(19) United States
(12) Patent Application Publication
(10) Pub. No.: US 2024/0118530 A1
(43) Pub. Date: Apr. 11, 2024

(54) AUTOFOCUS DEVICE FOR OPTICAL MICROSCOPE AND METHOD FOR MAINTAINING AUTOFOCUS

(71) Applicant: JL MEDILABS, INC., Cheongju-si (KR)

(72) Inventor: Jong Jin LEE, Cheongju-si (KR)

(21) Appl. No.: 17/928,270

(22) PCT Filed: Mar. 31, 2022
(86) PCT No.: PCT/KR2022/004618

§ 371 Date: Nov. 28, 2022

(30) Foreign Application Priority Data
Mar. 28, 2022 (KR) 10-2022-0038339

(51) Int. Cl. G02B 21/16; G02B 7/04; G02B 21/02

(52) U.S. Cl. CPC G02B 21/16; G02B 7/04; G02B 21/02

(57) ABSTRACT

The present invention relates to an autofocus device for an optical microscope that can accurately maintain the focus of an optical microscope, which is used to observe a sample using light, for a long period of time and a method for maintaining the focus. The autofocus device of the present invention includes a guide beam generation unit installed in a light source part of a fluorescence microscope to supply a guide beam in a direction towards a sample plane and a sample focus measurement unit measuring the guide beam reflected from the sample plane to detect a change in distance between the sample plane and an objective lens.

### TECHNICAL FIELD

The present invention relates to an autofocus device for an optical microscope and a method for maintaining the focus. More specifically, the present invention relates to an autofocus device for an optical microscope that can accurately maintain the focus of an optical microscope, which is used to observe a sample using light, for a long period of time and a method for maintaining the focus.

### BACKGROUND ART

An optical microscope is an optical instrument used to create and display a magnified image of a very small object or structure that is invisible to or difficult to see with the naked eye. Such optical microscopes are divided into fluorescence microscopes, metallurgical microscopes, polarization microscopes, interference microscopes, phase contrast microscopes, dark field microscopes, bright field microscopes, etc. based on their principles. A fluorescence microscope is an optical microscope that uses fluorescence for imaging. When a sample is illuminated with specific wavelengths that can be absorbed by a fluorescent material present in the sample, a fluorescence microscope can detect light of longer wavelengths in the form of fluorescence emitted from the fluorescent material.

A fluorescence microscope detects emitted light whose intensity is much weaker than illumination light through a wavelength-specific filter. A fluorescence microscope consists of a light source, an excitation filter, a dichroic mirror, and an emission filter. A xenon lamp, a mercury lamp, a LED or a laser is used as the light source. Only wavelengths of light emitted from the light source that are absorbable by a fluorescent material present in a sample pass through the excitation filter and are illuminated on the sample through the dichroic mirror. The fluorescent material absorbs light having the specific wavelengths and emits light of longer wavelengths in the form of fluorescence. The emitted light is not reflected by the dichroic mirror and is detected by a detector. A multicolor fluorescence microscope is provided with an excitation filter and a dichroic mirror corresponding to each color to image fluorescent materials of various colors present in a sample (see FIG. 2).

Fluorescence microscopes are used to image intracellular organelles and proteins and examples thereof include confocal microscopes and total internal reflection fluorescence microscopes.

Fluorescence microscopes measure the types and amounts of biomarkers attached with fluorophores by observing the biomarkers after excitation of the fluorophores. In order to identify the biomarkers, the fluorescence microscopes need to focus on the biomarkers upon initial operation and maintain this focus even during observation.

Conventional optical microscopes use visible light for initial focusing. Since conventional optical microscopes usually have low magnifications and large depths of field, the adjusted focus is maintained well even without any manipulation during observation. In contrast, a fluorescence microscope used for biomarker analysis may suffer from photobleaching when excitation light is irradiated for a long period of time to generate fluorescence. Particularly, since a fluorescence microscope is more sensitive to photobleaching particularly when a target biomarker is labeled with only one fluorescent molecule, it should acquire an image of a sample simultaneously with the supply of excitation light after the sample is focused. However, photobleaching inevitably occurs during focusing after the supply of excitation light in fluorescence microscopes, unlike in conventional optical microscopes (see FIGS. 2 to 4).

Single fluorescent molecules emit fluorescence whose signal intensity is very weak. Thus, a fluorescence microscope uses an objective lens with a high numerical aperture and a high magnification to collect fluorescent light emitted from single fluorescent molecules as much as possible. The use of the such objective lens causes a very small depth of field, and as a result, the sample may be defocused even though the distance between the objective lens and the sample is changed by only tens to hundreds of nanometers.

The distance between the objective lens and the sample should be maintained constant after the initial focus adjustment but may change over time due to thermal shrinkage or expansion, surrounding vibrations or an unstable sample moving stage while observing the sample. Thus, there is a need for a new device and method for automatically maintaining the distance between an objective lens and a sample.

### DISCLOSURE

### Technical Problem

In order to solve the above-described problems, the present invention is intended to provide an autofocus device that can accurately maintain the focus of an optical microscope for a long period of time and a method for maintaining the focus.

### Technical Solution

One aspect of the present invention provides an autofocus device including a guide beam generation unit installed in a light source part of a fluorescence microscope to supply a guide beam in a direction towards a sample plane and a sample focus measurement unit measuring the guide beam reflected from the sample plane to detect a change in distance between the sample plane and an objective lens.

In one embodiment, the autofocus device includes a beam splitter reflecting a portion of the guide beam and installed obliquely to a traveling direction of the guide beam wherein the guide beam supplied from the guide beam generation unit passes through the beam splitter, the guide beam is supplied to the sample plane, and is reflected from the sample plane and a portion of the guide beam reflected from the sample plane is reflected by the beam splitter and enters the sample focus measurement unit.

In one embodiment, the guide beam generation unit may supply the guide beam such that the relative direction and position of the guide beam with respect to an optical axis of the objective lens are controlled, and the optical axis of the objective lens and the guide beam may form an angle of 0° to 20°.

In one embodiment, the beam splitter may reflect 10 to 50% of the guide beam.

In one embodiment, the sample focus measurement unit may include a tube lens on which the guide beam reflected from the sample plane is incident and a camera for sample focus measurement determining the position of the guide beam having passed through the tube lens.

In one embodiment, the sample focus measurement unit may include a guide beam position monitor measuring a change in the position of the guide beam and a sample focal distance controller controlling the distance between the objective lens of the fluorescence microscope and the sample plane based on data measured in the guide beam position monitor.

In one embodiment, the sample focus measurement unit may include an excitation light blocking filter capable of blocking excitation light from entering the camera for sample focus measurement.

In one embodiment, the autofocus device may include a guide beam focus control means capable of controlling the focus of the guide beam between the guide beam generation unit and the sample focus measurement unit.

In one embodiment, the guide beam focus control means may include a control means installed in front of the guide beam generation unit and consisting of two or more lenses to change the focal distance of the guide beam incident on the sample plane or a control means installed in front of the sample focus measurement unit to change the focal position of the guide beam entering the camera for sample focus measurement.

The present invention also provides a method for autofocus measurement for a fluorescence microscope using the autofocus device.

In one embodiment, the method for autofocus measurement may include supplying a guide beam to a sample plane from the guide beam generation unit, determining the position of the guide beam reflected from the sample plane and entering the camera for sample focus measurement, and detecting a change in the position of the guide beam to control the distance between the objective lens of the fluorescence microscope and the sample plane.

In one embodiment, the method for autofocus measurement may include, before supplying a guide beam to a sample plane, supplying a sample for focus control to an objective part, controlling the distance between the objective lens and the sample plane to focus on the sample, and removing the sample for focus control and supplying a sample for fluorescence measurement.

In one embodiment, the determination of the position of the guide beam may include focusing the guide beam entering the camera for sample focus measurement using the guide beam focus control means.

### Advantageous Effects

The autofocus device for a fluorescence microscope according to the present invention does not use excitation light for focus control. Therefore, the autofocus device of the present invention can minimize photobleaching of fluorophores caused by long-term exposure to excitation light.

In addition, the autofocus device for a fluorescence microscope according to the present invention can accurately measure a minute change in distance between a sample plane and an objective lens and automatically control the distance between the sample plane and the objective lens based on the measured distance change, enabling the observation of fluorophores with a fluorescence microscope with further increased accuracy.

Furthermore, the autofocus device for a fluorescence microscope according to the present invention can correct a change in the focus of a guide beam caused by a difference in distance between a sample plane and an actual sample. Therefore, the autofocus device of the present invention can accurately control and maintain the focus using the guide beam over a wider range of distances.

### DESCRIPTION OF DRAWINGS

FIG. 1 illustrates the structure of a fluorescence microscope equipped with an autofocus device according to one embodiment of the present invention.

FIG. 2 illustrates a conventional autofocus device for a fluorescence microscope.

FIG. 3 illustrates another conventional autofocus device for a fluorescence microscope.

FIG. 4 illustrates another conventional autofocus device for a fluorescence microscope.

FIG. 5 illustrates behaviors of a guide beam in an objective lens and a sample plane in accordance with one embodiment of the present invention.

FIG. 6 illustrates behaviors of a guide beam when the distance between a sample plane and an objective lens increases in accordance with one embodiment of the present invention.

FIG. 7 illustrates behaviors of a guide beam when the distance between a sample plane and an objective lens decreases in accordance with one embodiment of the present invention.

FIG. 8 illustrates behaviors of a guide beam depending on where the guide beam is irradiated in accordance with one embodiment of the present invention.

FIG. 9 illustrates the structure of a fluorescence microscope capable of identifying biomarkers in accordance with one embodiment of the present invention.

FIG. 10 shows an emission spectrum of a fluorophore and a change in the emission spectrum of fluorescence having passed through an identification filter in accordance with one embodiment of the present invention.

FIG. 11 shows emission spectra of fluorescence having passed through an identification filter when a plurality of fluorophores were used in accordance with one embodiment of the present invention.

FIG. 12 shows emission spectra of fluorescence having passed through different types of identification filters in accordance with one embodiment of the present invention.

FIG. 13 shows absorption and emission spectra of fluorophores in accordance with one embodiment of the present invention.

FIG. 14 shows the preparation of a sample in accordance with one embodiment of the present invention.

FIG. 15 shows fluorescence from a sample in accordance with one embodiment of the present invention (a) before a spectroscopic element and (b) after passing through an identification filter and a spectroscopic element.

FIG. 16 shows changes in the movement and shape of a guide beam with varying distances between a sample plane and an objective lens in accordance with one embodiment of the present invention.

FIG. 17 shows the detection of pixel movements (including decimal points) of a guide beam in accordance with one embodiment of the present invention.

FIG. 18 shows a state in which the focus of a guide beam was controlled in accordance with one embodiment of the present invention.

### MODE FOR INVENTION

Preferred embodiments of the present invention will now be described in detail. In the description of the present invention, detailed explanations of related art are omitted when it is deemed that they may unnecessarily obscure the essence of the present invention. Throughout the specification, the singular forms “a”, “an” and “the” are intended to include the plural forms as well, unless the context clearly indicates otherwise. It is to be understood that the terms such as “including” or “having,” etc., are intended to indicate the existence of the features, numbers, steps, operations, components, parts, or combinations thereof disclosed in the specification, and are not intended to preclude the possibility that one or more other features, numbers, steps, operations, components, parts, or combinations thereof may exist or may be added. Respective steps of the methods described herein may be performed in a different order than that which is explicitly described. In other words, the respective steps may be performed in the same order as described, substantially simultaneously, or in a reverse order.

As the present invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

The present invention is not limited to the illustrated embodiments and may be embodied in various different forms. Rather, the disclosed embodiments are provided so that this disclosure will be thorough and complete, and will fully convey the scope of the invention to those skilled in the art. In the drawings, the dimensions, such as widths and thicknesses, of elements may be exaggerated for clarity. The drawings are explained from an observer's point of view. It will be understood that when an element is referred to as being “on” another element, it can be directly on the other element, or one or more intervening elements may also be present therebetween. It will be understood by those skilled in the art that various changes in form and details may be made therein without departing from the spirit and scope of the invention as defined by the appended claims. The same reference numerals represent substantially the same elements throughout the drawings.

As used herein, the term “and/or” encompasses both combinations of the plurality of related items disclosed and any item from among the plurality of related items disclosed. In the present specification, the description “A or B” means “A”, “B”, or “A and B.”

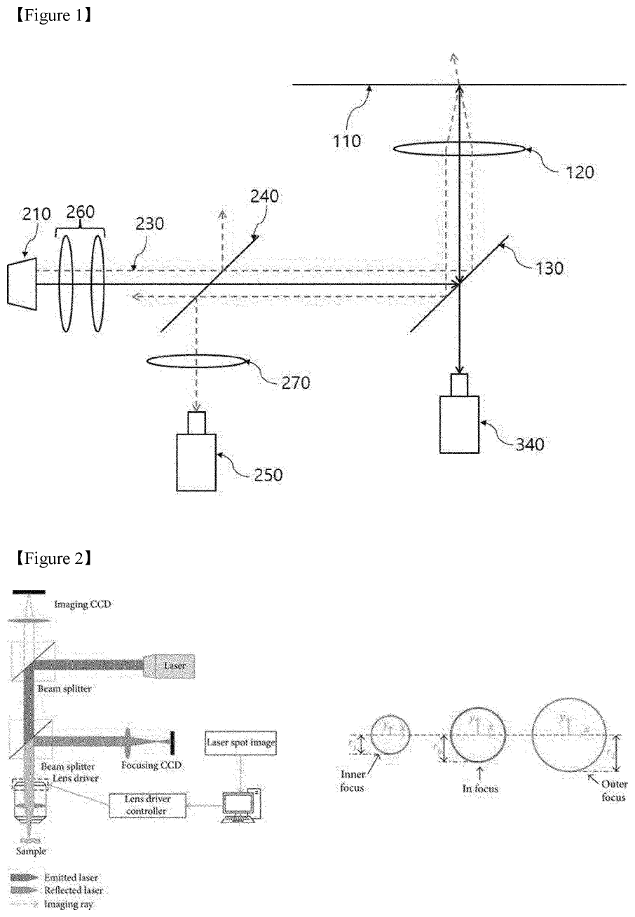

FIG. 1 illustrates the structure of an autofocus device according to the present invention.

The autofocus device of the present invention includes a guide beam generation unit installed in a light source part of a fluorescence microscope to supply a guide beam in a direction towards a sample plane and a sample focus measurement unit measuring the guide beam reflected from the sample plane to detect a change in distance between the sample plane and an objective lens.

The autofocus device and a method for maintaining the focus according to the present invention use separate light independent of light irradiated to observe the sample or light emitted from the sample. Accordingly, the autofocus device and the method of the present invention can be applied to all optical microscopes, most suitably fluorescence microscopes widely used in the fields of medicine and biology. Thus, the autofocus device and the method of the present invention will be described based on a fluorescence microscope.

The guide beam 230 is supplied from the light source part and its relative direction and position with respect to an optical axis of the objective lens can be controlled. That is, control over the direction and position depending on a desired precision of autofocus leads to an increase in precision or an increase in the distance at which autofocusing is possible (see FIG. 1).

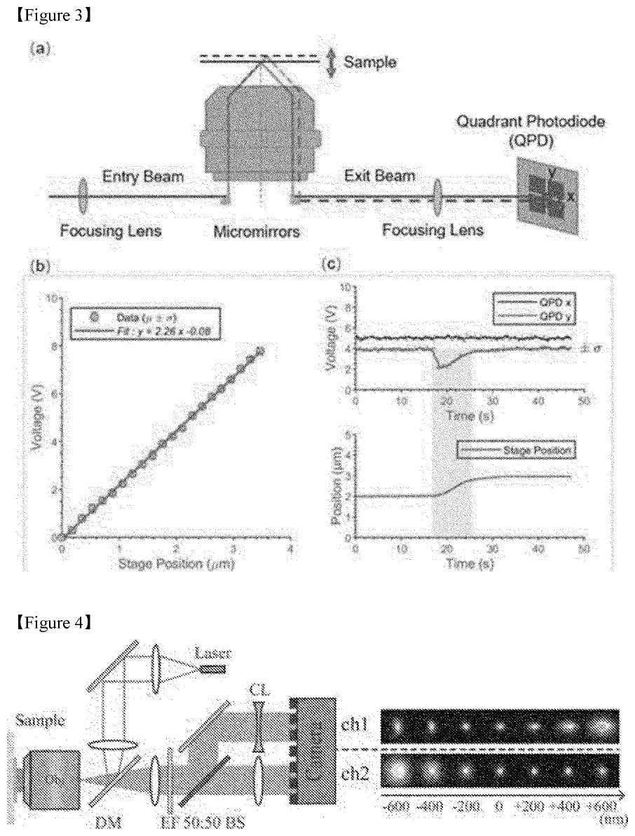

An autofocus device of a previous invention irradiates excitation light to generate fluorescence, which is then used for focusing. However, the autofocus device requires long-term use of the excitation light, which causes photobleaching (see FIGS. 2 and 4). In an attempt to solve this problem, a technique using a guide beam separate from excitation light has been developed (see FIG. 3). However, separate reflectors and devices for the guide beam should be used, resulting in an increase in the size of a fluorescence microscope. Further, since the excitation light and the guide beam operate separately from each other, a lot of effort is required to align them. In contrast, as described above, it is easy to control the direction and position of the guide beam and it is possible to use only the guide beam for focusing without the need for excitation light in the present invention, with the result that photobleaching can be minimized.

As discussed above, the guide beam 230 can be irradiated along an optical path passing through the guide beam generation unit, a dichroic mirror, and the sample plane (see FIG. 1). The guide beam 230 is sequentially reflected on the sample plane 110 and the dichroic mirror 130 and returns toward the light source, which can be observed by installing a beam splitter 240.

The beam splitter 240 is a translucent mirror that reflects a certain amount of light of specific wavelengths or light of all wavelengths. The beam splitter 240 can be used to reflect a portion of the guide beam.

In detail, the beam splitter 240 may be installed obliquely to the traveling direction of the guide beam 230. A portion of the guide beam generated by the guide beam generation unit may be reflected by the beam splitter and the remaining portion of the guide beam may be supplied to the sample plane 110 through the dichroic mirror 130. The guide beam supplied to the sample plane may be reflected from the surface of the sample plane and return toward the beam splitter 240 through the dichroic mirror. Also at this time, the beam splitter can reflect a certain amount of the guide beam. For easy observation of the guide beam, elements 250 and 270 of the sample focus measurement unit may be installed in a portion where the light reflected from the sample plane and reflected by the beam splitter is supplied. The elements 250 and 270 of the sample focus measurement unit will be described below. The guide beam is generated by the guide beam generation unit, passes twice through the beam splitter 240, and enters the sample focus measurement unit. As a result, only a small amount of the guide beam enters the sample focus measurement unit. The amount of the guide beam is not limited in the present invention as long as it can be used to determine the position of the guide beam. Therefore, even though the guide beam is diminished after passing through the beam splitter, its amount is sufficient to measure and control the focus.

It is preferable that the beam splitter reflects 10 to 50% of the guide beam. If the beam splitter reflects 10% of the guide beam, 90% of the guide beam generated by the guide beam generation unit can reach the sample plane. Assuming that 1% of the guide beam having reached the sample plane is reflected from the sample plane, 10% of the guide beam reflected from the sample plane, that is, 0.09% of the entire guide beam, enters the sample focus measurement unit. For the same reason, if the beam splitter reflects 50% of the guide beam, 0.25% of the total guide beam enters the sample focus measurement unit. Accordingly, if the beam splitter reflects less than 10% of the guide beam, the intensity of the guide beam entering the sample focus measurement unit may be lowered, resulting in a reduction in measurement efficiency. Meanwhile, if the beam splitter reflects more than 50% of the guide beam, the efficiency may be rather reduced. Particularly, when a laser with a power of 1 milliwatt is used, a power of several microwatts enters a camera. The power of several microwatts is sufficiently detected by a low-end camera. Accordingly, if the beam splitter reflects the amount of the guide beam outside the range defined above, the use of a high power laser or a sensitive camera is required.

The generated guide beam passes through the beam splitter 240, is reflected by the dichroic mirror 130, and is supplied to the sample plane 110.

The sample plane 110 may generally be the surface of a slide glass. In general, when biomarkers are analyzed using the fluorescence microscope, the biomarkers are attached to the surface of a substrate and reflection occurs due to a difference in refractive index between a slide glass and a buffer solution. Accordingly, the guide beam may be reflected from the surface of the slide glass.

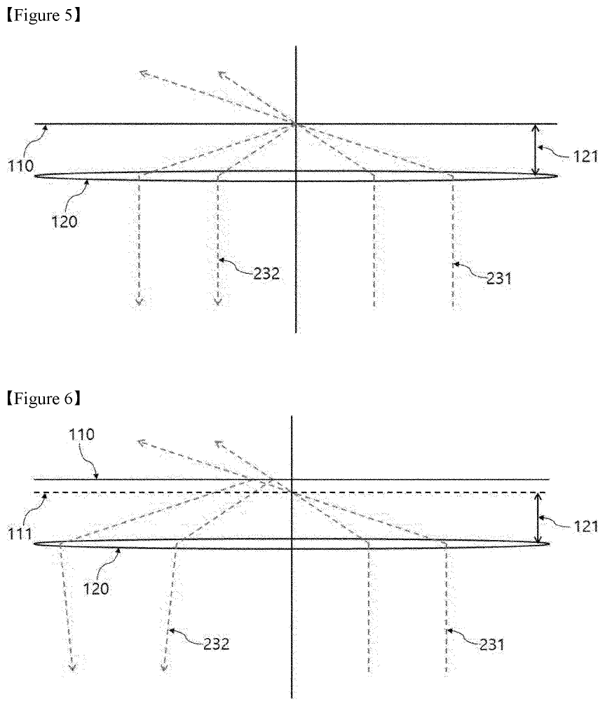

The guide beam 230 incident on the sample plane 110 may pass through the objective lens 120 positioned below the sample plane. The objective lens collects and magnifies light from the sample and the guide beam converges to one point (see FIG. 5).

The sample plane 110 is focused such that the sample is clearly observed, as will be described below. That is, since the focal plane of the objective lens coincides with the sample plane where the sample is located, the guide beam may be reflected from the sample plane, pass through the objective lens again, and return to the sample focus measurement unit (see FIG. 5).

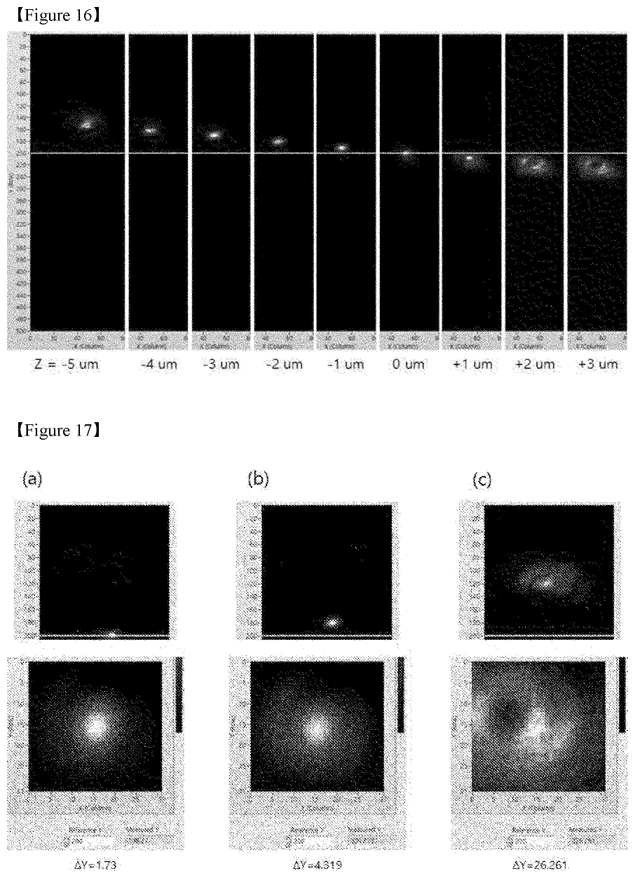

That is, in the focused state, the guide beam can be observed by the sample focus measurement unit. At this time, the guide beam can be captured at a predetermined position of the sample focus measurement unit (see FIGS. 16 and 17). The position of the sample focus measurement unit where the guide beam is captured may be determined depending on the relative direction and position of the guide beam with respect to an optical axis of the objective lens. That is, when the distance between the optical axis of the objective lens and the center of the guide beam increases (234), the guide beam can be observed at the edge of the sample focus measurement unit. Meanwhile, when the distance between the optical axis of the objective lens and the center of the guide beam decreases (233), the guide beam can be observed at the central portion of the sample focus measurement unit (see FIG. 8).

When the center of the guide beam is positioned away from the optical axis of the objective lens, the guide beam may be incident on the edge of the objective lens. In this case, a minute change in focus can be more reliably measured but the measurement range may be limited. Further, when the distance between the objective lens and the sample plane is greatly changed, the guide beam may deviate from the observation range.

Meanwhile, when the center of the guide beam is close to the optical axis of the objective lens, the precision of focus change measurement may be reduced but the measurement range may be increased. In addition, the guide beam can be used even when the distance between the objective lens and the sample plane is greatly changed.

The direction of the guide beam may be controlled to form an angle of 0 to 20° with the optical axis of the objective lens. If the direction of the guide beam and the optical axis of the objective lens form an large angle, a minute change in focus can be more reliably measured but the measurement range may be limited. Further, when the distance between the objective lens and the sample plane is greatly changed, the guide beam may deviate from the observation range.

Meanwhile, if the direction of the guide beam and the optical axis of the objective lens form an small, the precision of focus change measurement may be reduced but the measurement range may be increased. In addition, the guide beam can be used even when the distance between the objective lens and the sample plane is greatly changed.

After completion of the focusing, the position of the guide beam can be determined by the sample focus measurement unit and can be used to maintain the distance between the sample plane and the objective lens.

In detail, when the distance between the sample plane 110 and the objective lens increases after focusing using the sample and the guide beam (see FIG. 6), the guide beam 231 incident on the sample plane moves to the edge and is reflected from the sample plane. Since the sample plane 110 is located behind the focal plane 111, the reflected guide beam may not be parallel light but convergent light. Accordingly, when the guide beam is observed using the sample focus measurement unit, the guide beam moves to the edge with increasing distance between the sample plane and the objective lens, and at the same time, the focus is blurred.

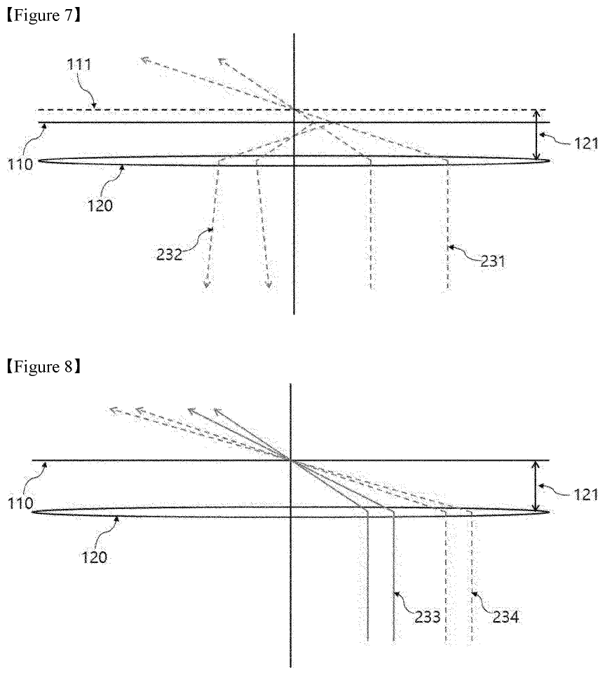

Meanwhile, when the distance between the sample plane 110 and the objective lens decreases (see FIG. 7), the guide beam 231 incident on the sample plane moves to the center and is reflected from the sample plane (232). Since the sample plane 110 is located in front of the focal plane 111, the reflected guide beam may not be parallel light but divergent light. Accordingly, when the guide beam is observed using the sample focus measurement unit, the guide beam moves to the center with decreasing distance between the sample plane and the objective lens, and at the same time, the focus is blurred.

Taken together, when the distance between the sample plane and the objective lens is changed, the position of the guide beam observed in the sample focus measurement unit can move and can be used to accurately maintain the distance between the objective lens and the sample plane. Since the guide beam moves linearly depending on the difference in distance between the objective lens and the sample plane, the focus of the fluorescence microscope can be accurately maintained for a long period of time by changing the position of the sample plane or the objective lens such that the position of the guide beam observed in the sample focus measurement unit is maintained constant.

In order to accurately measure the distance between the sample plane and the objective lens, the shape of the guide beam observed in the sample focus measurement unit can be fitted with a Gaussian function or a Poisson function. A conventional focus adjustment device directly measures fluorescence emitted by excitation light for focusing. However, this approach has low accuracy and requires a lot of time, causing photobleaching, because the focus is adjusted based on the intensity of fluorescence. Further, the observed fluorescence follows a Poisson distribution, making it difficult to accurately determine the position of the center.

A CCD can be used for the adjustment and observation. However, a CCD can measure only differences in the brightness of pixels because it can observe the guide beam on a pixel basis and has difficulty in detecting movements at distances of less than 1 pixel. A fluorescence microscope observes only blurry images due to its small depth of field, as discussed above, even though the focal distance is changed by only tens to hundreds of nanometers. Accordingly, when a fluorescence microscope observes the guide beam on a pixel basis, it is impossible to accurately adjust the focal distance.

In the present invention, these drawbacks are overcome by fitting the guide beam observed in the sample focus measurement unit with a Gaussian function or a Poisson function to find the central point of the guide beam in pixels up to decimal points. Based on this, it is possible to accurately control the distance between the sample plane and the objective lens.

The brightness of each of the pixels in the measured bottom images of FIG. 17 is input to the following 2-dimensional Gaussian function:

$$f ( x , y ) = {Ae}^{- ( \frac{{( x - {x}_{0} )}^{2}}{2 {σ}_{0}^{2}} + \frac{{( y - {y}_{o} )}^{2}}{2 {σ}_{o}^{2}} )} + B$$

and x₀ and y₀ are calculated to find the central point of the guide beam in pixels up to decimal points.

The sample focus measurement unit may include a tube lens on which the guide beam reflected from the sample plane is incident and a camera for sample focus measurement determining the position of the guide beam having passed through the tube lens.

The tube lens 270 is a lens for observing the guide beam and serves as an ocular lens of the optical microscope. The tube lens adjusts the focus of the reflected and incident guide beam and is controlled such that an accurate image is created. The tube lens may be a combination of 1 to 10 lenses. The tube lens 270 may be omitted when the objective lens 120 has a finite focal distance.

The camera 250 for sample focus measurement is used to observe the guide beam. The camera 250 may include a CCD or CMOS in which a plurality of elements are arranged, as discussed above. In a conventional focusing device using a guide beam, a quadrant photodiode (QPD) is used to observe the guide beam. However, the QPD measures only a difference in light intensity at left and right sides or upper and lower sides to observe the position of the guide beam.

When the distance between the sample plane and the objective lens varies, not only the position of the observed guide beam may be changed, as discussed above, but also the guide beam may not be maintained in its original shape and may be deformed, as shown in FIG. 16. In the case where a QPD is used to determine the position of the guide beam (see FIG. 3), it can accurately measure the position of the guide beam when the guide beam maintains its original shape. However, the QPD using a difference in the light intensity measured simply by photodiodes cannot determine the accurate position of the guide beam when there is a large difference in light intensity at left and right sides or upper and lower sides as a result of a change in the shape of the guide beam.

Since the guide beam should be positioned between left and right photodiodes or upper and lower photodiodes, a large change in distance between the sample plane and the objective lens may not be detected by the QPD.

In contrast, in the present invention, the position of the guide beam is determined using a CMOS or CCD and a change in distance between the sample plane and the objective lens is measured based on a change in the position of the guide beam, as discussed above. Accordingly, even when the shape of the guide beam is changed, the central point can be found by fitting with a Gaussian function or a Poisson function and moved, as discussed above. In addition, even when the distance between the sample plane and the objective lens is greatly changed, the position of the guide beam can be measured with the CMOS or CCD. The CMOS or CCD may be constructed to have an observation range equal to or greater than that of the objective lens. In this case, the guide beam can be prevented from deviating to the outside of the image sensor, which makes it impossible to measure the focus.

The sample focus measurement unit may include a guide beam position monitor measuring a change in the position of the guide beam and a sample focal distance controller controlling the distance between the objective lens of the fluorescence microscope and the sample plane based on data measured in the guide beam position monitor.

As discussed above, the guide beam observed in the sample focus measurement unit can be used to accurately observe a change in distance between the sample plane and the objective lens in real time, making it possible to keep the distance between the sample plane and the objective lens constant.

The guide beam position monitor determines the initial position of the guide beam and determines how much the observed guide beam moves from the initial position. The position of the guide beam can be designated as a pixel size including decimal points by using a Gaussian function or a Poisson function, as discussed above. Even when the position of the guide beam is changed, this fitting is continued to designate the position, making it possible to measure the positional change of the guide beam in pixels up to decimal points. The distance between the sample plane and the objective lens increases when the guide beam moves to the peripheral region of the sample focus measurement unit and decreases when the guide beam moves toward the central region of the sample focus measurement unit. Based on this, the sample focus measurement unit can precisely adjust the distance between the sample plane and the objective lens.

The sample focal distance controller controls the distance between the sample plane and the objective lens using signals transmitted from the guide beam position monitor. The sample focal distance controller moves the sample plane or the objective lens forward and backward to maintain the focal distance. For this purpose, a focal distance controller may be installed in the objective lens or an objective part to which the sample is supplied. The focal distance controller controls the positions of the objective lens and the sample plane based on signals generated by the guide beam position monitor such that the guide beam is observed at a certain position.

The sample focus measurement unit may include an excitation light blocking filter capable of blocking excitation light from entering the camera for sample focus measurement. The guide beam may have an optical axis and an optical path in the same direction as excitation light but may be used independently from excitation light. The guide beam may be split by the beam splitter and enter the sample focus measurement unit. The beam splitter may reflect a portion of the excitation light. In this case, the reflected portion of the excitation light can enter the sample focus measurement unit, making it difficult to determine the exact position of the guide beam. It is thus preferable that an excitation light blocking filter is installed in the sample focus measurement unit to block excitation light from entering the sample focus measurement unit. The excitation light blocking filter is preferably a filter that can pass the guide beam therethrough while blocking excitation light. To this end, the excitation light and the guide beam are preferably selected such that their emission spectra do not overlap each other. Generally, since the wavelengths of excitation light to excite fluorophores attached to biomarkers are predetermined, it is preferable that the excitation light is selected corresponding to the fluorophores and then a guide beam whose wavelength does not overlap with that of the excitation light is selected.

The autofocus device may include a guide beam focus control means capable of controlling the focal distance or focal position of the guide beam between the guide beam generation unit and the sample focus measurement unit. Even when the guide beam is used for focusing, the reflection plane (sample plane) of the guide beam may be different from the observation point of the sample.

In detail, the sample plane may be the surface of a slide glass, as described above. When it intends to observe thick objects such as cells or tissues, the positions of biomarkers that actually generate fluorescence are distant from the surface of the slide glass. Accordingly, in the case where a sample for focusing is used for focusing and then the guide beam is used to maintain the focus, a difference in distance between the sample and the guide beam may cause the guide beam to be out of focus.

For the purpose of compensating for a change caused by the distance difference, a guide beam focus control means capable of controlling the focal distance or focal position of the guide beam may be installed between the guide beam generation unit and the sample focus measurement unit. The guide beam focus control means can convert the guide beam into diverging light or converging light and supply the converted light to the sample focus measurement unit or can control the focal position of the guide beam reflected from the sample plane once again and supply the guide beam to the sample focus measurement unit.

The guide beam focus control means is installed in front of the guide beam and consists of two or more lenses to change the focal distance of the guide beam incident on the sample plane. The focus control means converts the supplied guide beam into divergent light or converging light and supplies the divergent light or converging light to the sample focus measurement unit to change the focal distance of the guide beam. Based on this, the focus control means can match the observation point of biomarkers to the focus of the guide beam. The guide beam focus control means may be a combination of two or more lenses and can convert the guide beam, which is parallel light, into diverging light or converging light. Preferably, the guide beam focus control means is a combination of two convex lenses. The distance between the two convex lenses is made shorter or longer than twice the focal distance to convert the guide beam into diverging light or converging light.

The guide beam focus control means may be installed in front of the sample focus measurement unit to change the focal distance of the guide beam incident on the camera for sample focus measurement. If the guide beam is defocused, it may be changed into diverging light or converging light when reflected from the sample plane, as discussed above. Accordingly, a clear image of the guide beam can be obtained by installing the guide beam focus control means in front of the sample focus measurement unit to control the focus of the guide beam entering the sample focus measurement unit.

The fluorescence microscope used in the present invention can observe fluorescence generated from a sample and may consist essentially of an objective part 100, a light source part 200, and a detection part 300.

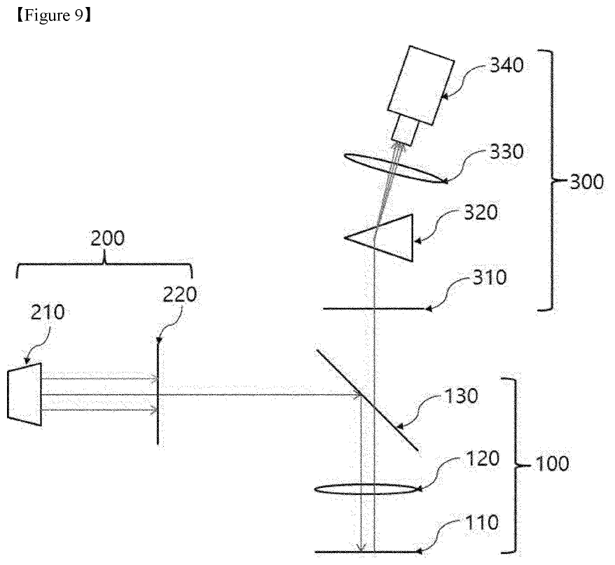

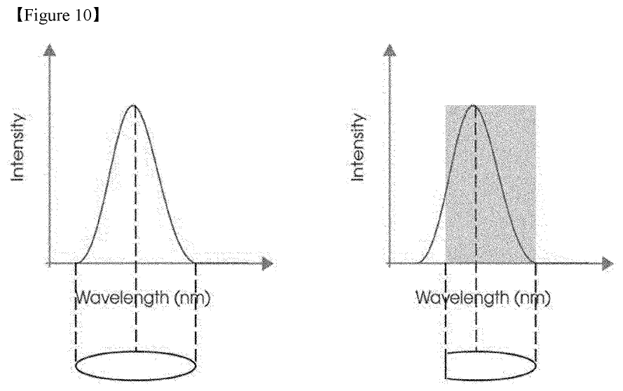

In the objective part 100, a sample 110 is seated and fixed for easy observation. The objective part 100 includes a fixing means for fixing the sample 110. An objective lens 120 may be installed in the objective part 100 to supply excitation light to the sample 110 and collect/magnify fluorescence emitted from the sample 110. A dichroic mirror 130 may be installed in the objective part 100 to reflect excitation light supplied from the light source part 200 and supply the excitation light toward the sample. At the same time, fluorescence generated from the sample 110 is transmitted to the detection part through the dichroic mirror 130 (see FIG. 9).

The dichroic mirror 130 is a type of mirror that reflects light in a specific wavelength band and transmits light in the remaining wavelength bands therethrough. The dichroic mirror used in the present invention transmits the fluorescence therethrough while reflecting the excitation light. In conclusion, the excitation light is incident on the dichroic mirror and the fluorescence is transmitted through the dichroic mirror.

The light source part 200 generates excitation light to excite fluorophores present in the sample. An excitation filter 220 may be installed in the light source part 200 to supply only excitation light necessary for the sample. Only light of wavelengths capable of exciting the fluorophores attached to the sample among the wavelengths of light supplied from a light source 210 of the light source part may transmit through the excitation filter 220. It is preferable that the excitation filter 220 is attached interchangeably so as to produce excitation light of various wavelengths.

Any source that can emit light including the wavelengths of the excitation light may be used as the light source 210. Preferably, the light source 210 is a high color rendering white light emitting device. The high color rendering white light emitting device has an emission spectrum that is smoothly distributed over the entire visible light region and emits light such that the spectrum extends to the ultraviolet region, which is widely used as excitation light. That is, the white light emitting device has an emission pattern similar to that of sunlight. Since the high color rendering light emitting device uses a mixture of various luminescent materials and fluorescent materials for light emission, the excitation filter 220 can be used to produce excitation light having a desired spectrum. Particularly, a conventionally used light source supplies only light with a narrow spectrum and thus needs to be exchanged with a new one when excitation light having a spectrum other than the spectrum supplied from the light source is required. In contrast, the use of the high color rendering light emitting device enables the production of desired excitation light only by exchanging the excitation filter 220 with a new one without the need to replace the light source.

Alternatively, a monochromatic light emitting laser may be used as the light source instead of the white light emitting device. It is preferable that monochromatic light emitted from the laser excites the fluorophores simultaneously. The laser may have a higher light intensity than the light emitting device and can emit monochromatic light having a narrow spectral band. Accordingly, the laser can excite the fluorophores more brightly and is thus preferable as long as the fluorophores use the same excitation light. However, the use of the high color rendering white light emitting device is preferable when a wide spectrum is required to excite the fluorophores. It is thus preferable to select and use an appropriate light source depending on experimental conditions.

An autofocus device is installed in the light source part 200 and the guide beam 230 can be used to measure and automatically maintain the focus on the sample plane, which are the same as those discussed above.

The detection part 300 is installed to observe fluorescence generated from the sample and includes a tube lens 330 for easy observation of the fluorescence.

Since a conventionally used fluorescence microscope simply measures the peak wavelength of fluorescence to identify the type of the fluorescence, it has the disadvantage that when fluorescence having a similar peak wavelength is used, the type of the fluorescence and the type of the sample attached with the fluorophores cannot be identified and has the problem that a plurality of cameras for different colors should be used to detect fluorescence generated by fluorophores, resulting in increased size and cost of the system. Another problem is that since fluorophores with distinct peak wavelengths have different absorption spectra, the use of multiple types of excitation light is inevitable.

In order to overcome these drawbacks, a technique is used in which after fluorescence generated from a sample is split into two paths, a difference between the original position and the position of the dispersed light is used to identify the fluorescence. Since the technique uses the positional difference for detection rather than the color of fluorescence, the use of a single detector is possible. The technique can be used even when the overlap between the fluorescence spectra is large. The technique combines two images to determine a light emitting point (path 1) and the position of the dispersed light (path 2) and uses a relative difference between the light emitting point and the position of the dispersed light to identify the type of the sample. However, since fluorescence should be split into two paths for observation: path 1 for determining the light emitting point of the fluorescence and path 2 for light dispersing, the detection area is narrowed and the sensitivity is lowered.

In the present invention, an identification filter blocking a portion of the fluorescence spectrum is installed in the detection part to determine the type of the fluorescence without dividing the optical path.

The excitation light supplied from the light source part 200 allows the fluorophores attached to the sample 110 to emit fluorescence. The fluorescence is supplied to the detection part 300 through the dichroic mirror 130. A spectroscopic means 320 is installed in the detection part 300. The fluorescence having passed through the spectroscopic means 320 is dispersed depending on its wavelengths and can be observed in an elliptical shape (see the spectrum on the left side of FIG. 10).

In the present invention, the identification filter 310 is used to block some wavelengths of the fluorescence, and as a result, the fluorescence can be observed in the form of an ellipse whose one or both sides are truncated (see the right spectrum of FIG. 10). That is, the type of the fluorescence can be identified by determining the relative position and length of the fluorescence dispersed into light in an elliptical shape from the blocked point.

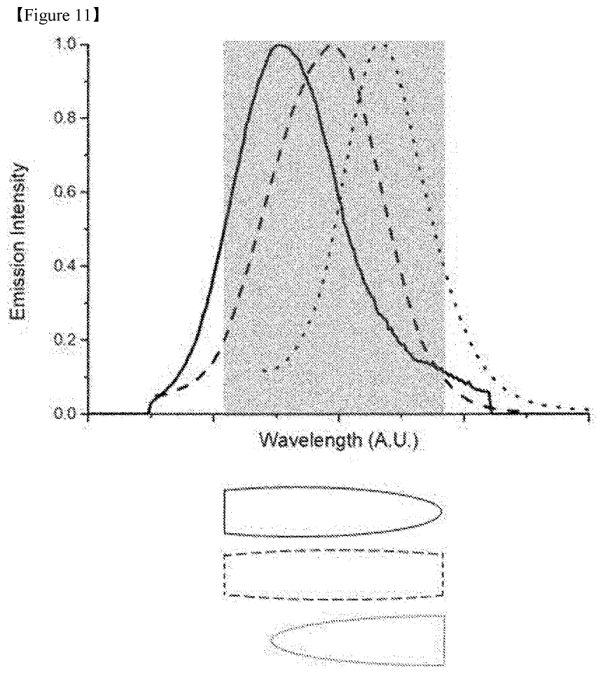

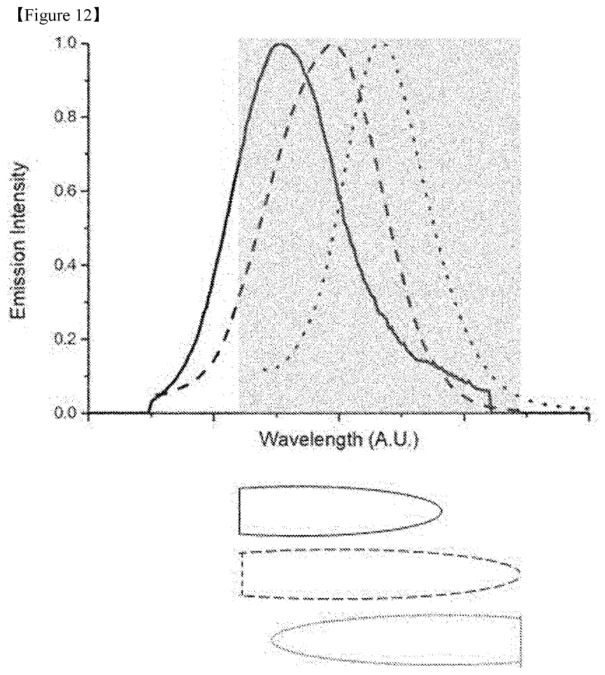

The spectrum of the fluorescence emitted from the sample 110 may vary depending on the type of the fluorescence. In the case where the fluorescence passes through an identification filter blocking certain wavelengths, the fluorescence can be observed in the form of an ellipse whose portion is truncated when dispersed. This truncated location can be determined by a relative combination of the spectral distribution of the fluorescence and the wavelengths blocked by the identification filter (see FIGS. 11 and 12).

For example, after red fluorescence having a spectral distribution of 470-670 nm and an emission peak of 530 nm passes through an identification filter blocking wavelengths of 500 nm or less, it can be observed in the form of an ellipse whose left portion is truncated (when dispersed such that light of short wavelengths moves to the left). Alternatively, when an identification filter blocking wavelengths of 600 nm or more is used, fluorescence can be observed in the form of an ellipse whose right side is truncated. That is, when an appropriate identification filter is used, fluorescence can be observed in the form of an ellipse whose truncated portion varies depending on its type, indicating that the fluorescence can be identified only by selecting and using an appropriate identification filter.

When spectral peaks of two types of fluorescence are close to each other, the types of fluorescence can be identified by the relative difference of the truncated elliptical shapes of the fluorescence, indicating that different types of fluorescence can be identified even when a plurality of fluorophores whose emission peaks are close to each other are used simultaneously (see FIG. 11).

For easy identification, the identification filter 310 can block a portion of the spectrum of fluorescence having a short wavelength emission peak emitted from the sample and/or a portion of the spectrum of fluorescence having a long wavelength emission peak emitted from the sample.

Generally, the brightest fluorescence is observed in an emission peak band of an emission spectrum. Accordingly, it is preferable to block a portion of the emission spectrum except the peak band of the emission spectrum. However, even in the case where a portion including the emission peak band is blocked, fluorescence can be observed due to the remaining portion. Thus, it is preferable to use an identification filter capable of blocking a portion of the fluorescence spectrum.

For easy identification, the identification filter 310 can block wavelengths shorter than the peak wavelength of the spectrum of fluorescence having a short wavelength emission peak emitted from the sample and wavelengths longer than the peak wavelength of the spectrum of fluorescence having a long wavelength emission peak emitted from the sample. The fluorescence spectrum having a short wavelength emission peak appears in a shape in which wavelengths shorter than the peak wavelength are removed. The fluorescence spectrum having a long wavelength emission peak appears in a shape in which wavelengths longer than the peak wavelength are removed. For the remaining fluorescence, the peak wavelength is located between the two types of fluorescence (see FIG. 11). Accordingly, the fluorescence spectrum having a short wavelength emission peak and the fluorescence spectrum having a long wavelength emission peak can act as kinds of reference points. The shape of the ellipse and the relative difference in position from the blocked portion are measured based on the reference points to identify the type of fluorescence.

In this case, the fluorescence having a short wavelength emission peak is preferably one having the shortest wavelength emission peak and the fluorescence having a long wavelength emission peak is preferably one having the longest wavelength emission peak. The effect of the identification filter can be maximized by blocking wavelengths shorter or longer than the peak wavelength of fluorescence having the shortest or longest emission peak.

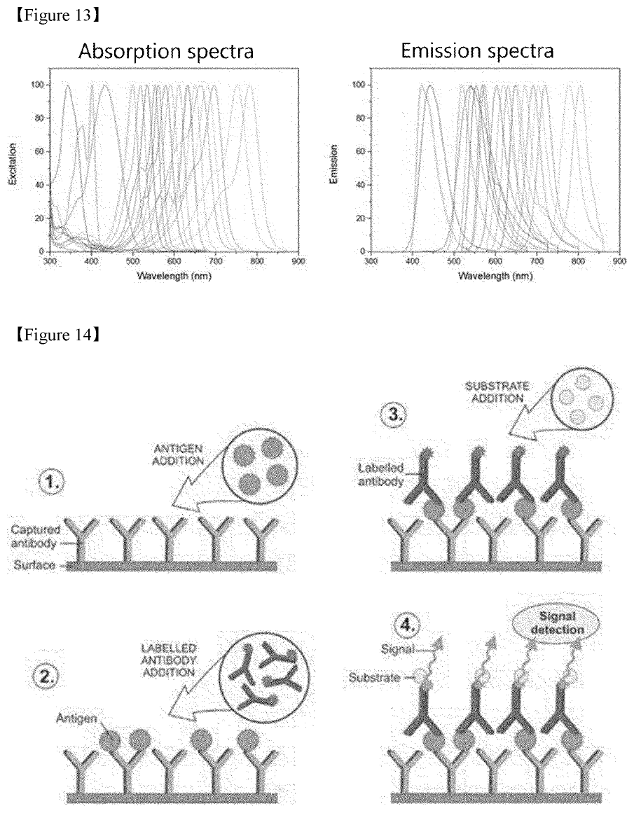

The fluorescence emitted from the sample has 2 to 100 emission peaks. Some or all of the emission spectra having the individual peaks may overlap. According to the present invention, a plurality of types of fluorescence can be identified, as described above, and each is preferably observed in the form of an ellipse whose one or both sides are truncated by the identification filter. Therefore, it is preferable that some or all of the emission spectra of the fluorescence overlap (see FIG. 11). In this case, the identification filter blocks some of the emission spectra to identify the fluorescence. Generally, the excitation spectra also overlap each other when the emission spectra overlap (see FIG. 13). Thus, also when one type of excitation light is used in the light source part, all fluorophores can be excited. As a result, not only one light source but also excitation light having one wavelength can be used in the present invention to allow all fluorophores in the sample to emit light. Since the fluorescence can be identified using the identification filter, the present invention offers greatly improved convenience compared to conventional fluorescence assays.

When it intends to identify more types of fluorescence simultaneously, a plurality of types of excitation light can also be used because one type of excitation light cannot be used to allow all fluorophores to emit light. As discussed above, it is most preferable to excite all fluorophores with one type of excitation light. However, in the case where a plurality of types of fluorescence need to be detected, the use of increased amounts of fluorophores is inevitable. In this case, it is impossible to excite all fluorophores with one type of excitation light and it is thus preferable to use a plurality of types of excitation light. Since different types of fluorescence have different peak absorption wavelengths, a plurality of types of excitation light can be supplied simultaneously or sequentially to obtain an optimal image even when all fluorophores can be excited with one type of excitation light.

According to the present invention, fluorophores having similar emission peaks can be identified, as described above. Specifically, fluorophores having 2 to 100 emission peaks can be identified simultaneously, enabling simultaneous identification of multiple samples.

The sample may include capture probes attached to a substrate, biomarkers bound to the capture probes, and detection probes bound to the biomarkers and including fluorophores. 2 to 100 types of detection probes may be arranged on the surface of the substrate.

The sample may be one that is generally used for fluorescence analysis, particularly for immunological analysis of biomarkers in the art (see FIG. 14).

Specifically, different capture probes may be attached to individual points on the substrate and may be bound with specific biomarkers (antigen-probe binding). When a bodily fluid containing the biomarkers is supplied onto the substrate, the biomarkers may be bound to the capture probes attached to the specific points on the surface of the substrate.

One or more types of fluorophores may be attached to the detection probes and the biomarkers bound with the detection probes may have one or more emission peaks.

After the attachment of the biomarkers is completed, the detection probes capable of specifically binding to the corresponding biomarkers are supplied. One type of fluorophore may be attached to the detection probes to emit fluorescence having one emission peak, or two or more types of fluorophores may be attached to the detection probes to emit fluorescence having two or more emission peaks. Even when other types of detection probes including the same or different types of fluorophores are used, all detection probes can be distinguished simultaneously or independently.

That is, different fluorophores or a combination of two or more types of fluorophores may be attached to the detection probes depending on the type of the detection probes. Accordingly, the biomarkers attached with the detection probes can emit fluorescence having a specific emission peak or two or more emission peaks.

Fluorescence can be generated from specific points on the substrate by the detection probes bound to the biomarkers. The type of the fluorescence can be identified by morphological analysis of the fluorescence.

The detection part 300 may include a spectroscopic means 320 for dividing fluorescence emitted from the sample. Since the fluorescence supplied to the detection part 300 is emitted from the fluorophores attached to the sample 110, it may have a simple circular shape. In the present invention, it is preferable that the fluorescence is dispersed depending on the spectral wavelength for analysis. Thus, a spectroscopic means 320 capable of dispersing the fluorescence can be installed in the detection part.

The spectroscopic means 320 may be used without limitation as long as it is capable of dispersing the fluorescence. Preferably, the spectroscopic means 320 is a prism or a diffraction grating.

The identification filter 310 may be installed in front or rear of the spectroscopic means 320. The fluorescence passing through the spectroscopic means 320 may be dispersed in an elliptical shape, as described above. In the present invention, the identification filter 310 is used to block some wavelengths of the fluorescence. The identification filter 310 may consist of one or more long-pass filters, short-pass filters, band-pass filters or a combination thereof. The long-pass filter is a filter through which a relatively long wavelength band passes and can block short wavelengths. In contrast, the short-pass filter is a filter through which a relatively short wavelength band passes and can block long wavelengths. In the present invention, a combination of a long-pass filter and a short-pass filter may be used as the identification filter. In this case, only a certain band can pass through the identification filter. Alternatively, the identification filter may be a band-pass filter through which only wavelengths in a certain band pass.

The present invention also provides a method for autofocus measurement for a fluorescence microscope using the autofocus device. The method for autofocus measurement includes supplying a guide beam to a sample plane from the guide beam generation unit, determining the position of the guide beam reflected from the sample plane and entering the camera for sample focus measurement, and detecting a change in the position of the guide beam to control the distance between the objective lens of the fluorescence microscope and the sample plane.

A fluorescence microscope observes only blurry images due to its small depth of field, as discussed above, even though the focal distance is changed by only tens to hundreds of nanometers, making it impossible to obtain a clear fluorescence image. In consideration of this, the method for autofocus measurement according to the present invention uses the autofocus device in the light source part and can measure a change in focus caused by a minute movement in real time. Based on this, the distance between the sample plane and the objective lens can be controlled to obtain a clear fluorescence image.

Focus adjustment using a guide beam can be performed before supplying the biomarkers attached with the fluorophores to the objective part of the fluorescence microscope or before irradiating excitation light to the biomarkers supplied to the objective part. A basic fluorescence microscope uses a fluorescence image created by excitation light for focusing, whereas the method for autofocus measurement according to the present invention uses a guide beam for focusing, thus minimizing photobleaching caused by long-term irradiation with excitation light.

For initial focusing, it is preferable to adjust the focus after supply of a sample for focusing to the objective part. The direct use of biomarkers causes photobleaching problems, as discussed above, and the quantity of biomarkers is finite. Thus, it is preferable for initial focusing that after the focus is adjusted using a sample for focus adjustment, the sample for focus adjustment is removed and a sample containing biomarkers is supplied. That is, after the focus of the objective part is adjusted using the sample for focusing, the guide beam is irradiated and the focus adjustment is finished by determining the position of the guide beam in the sample focus measurement unit. Thereafter, the sample for focus adjustment is removed and an actual sample containing biomarkers is supplied for fluorescence observation. At this time, the guide beam is continuously irradiated to measure the distance between the sample plane and the objective lens while maintaining the distance between the sample plane and the objective lens using the autofocus device, enabling the acquisition of a clear fluorescence image.

After completion of the focus adjustment using the sample for focusing, the guide beam is irradiated and its position is determined using the sample focus measurement unit installed in the autofocus device. At this time, the angle and position of the guide beam generation unit can be adjusted such that the guide beam is observed at an appropriate position in the sample focus measurement unit. Due to the difference in depth between the sample plane and the actual sample, the guide beam may be defocused, as discussed above. In this case, a guide beam focus control means can be used to clearly observe the guide beam.

After completion of the alignment of the guide beam, the sample for focusing is removed and a sample containing biomarkers attached with fluorophores is supplied to the objective part for observation.

During the observation, the distance between the sample plane and the objective lens is changed, making the focus of the fluorophores blurry. This distance change can be confirmed by the movement of the guide beam observed in the sample focus measurement unit. Depending on this movement, the distance between the focal plane and the objective lens can be adjusted in real time such that the fluorescence image is prevented from blurring.

After completion of the alignment of the guide beam, a sample containing biomarkers having similar thicknesses, such as a cell or tissue sample, is repeatedly observed. In this case, there is no need for additional alignment of the guide beam.

The present invention also provides a method for identifying biomarkers, including preparing a sample attached with fluorophores, positioning the sample in an objective part of a fluorescence microscope, supplying excitation light to the sample using a light source, blocking a portion of the fluorescence spectrum emitted by the excitation light using an identification filter, dispersing the fluorescence having passed through the identification filter, and identifying the type of the sample using the dispersed fluorescence.

The sample attached with fluorophores is prepared by attaching biomarkers and fluorophores to a substrate in a similar manner to in a general fluorescence assay. That is, the sample may be prepared by attaching capture probes to a substrate, binding biomarkers to the capture probes, and attaching specific detection probes to the biomarkers. As discussed above, due to the presence of fluorophores, the detection probes can emit fluorescence having a certain spectrum by the supply of excitation light, which will be described below (see FIG. 14).

The probes may be used without limitation as long as they can be attached with the biomarkers. Examples of the probes include antibodies, nanobodies, variants of antibodies such as single-chain fragment variables (scFvs), and aptamers.

The sample thus prepared is placed in an objective part of a fluorescence microscope and excitation light is supplied to the sample using a light source. The excitation light means light that supplies energy such that the fluorophores present in the sample emit light. The excitation light is used to excite some electrons of the fluorophores. The excited electrons emit fluorescence of certain wavelengths while returning to their ground state. Accordingly, it is preferable to excite the fluorophores using appropriate types of excitation light. In the present invention, the same excitation light can be used for a sample containing 2 to 100 types of fluorophores, as discussed above.

The fluorescence emitted by the excitation light may enter a detection part. A portion of the fluorescence spectrum may be blocked by an identification filter installed in the detection part (see FIGS. 11 and 12). The fluorescence whose wavelengths are partially blocked can be dispersed through a spectroscopic means and is observed in the form of an ellipse whose one or both sides are truncated, as described above, with the result that the type of the fluorescence and even the type of the sample attached with fluorophores can be identified.

In detail, the identification of the type of the sample may include recognizing a point where the dispersed fluorescence is blocked, determining the relative position and length of the dispersed fluorescence from the blocked point, and identifying the type of the sample based on the relative position and length of the fluorescence.

The dispersed fluorescence can be observed in an elliptical shape depending on its wavelength and intensity (see the left spectrum of FIG. 10). In detail, the fluorescence having passed through the spectroscopic means may be arranged long depending on its wavelengths because short wavelengths have high refractive indices (i.e. large angles of refraction) and long wavelengths have low refractive indices (i.e. small angles of refraction). The middle portion of the arranged fluorescence contains an emission peak that is observed brighter, i.e. thicker than both ends. Taken together, the fluorescence having passed through the spectroscopic means can be observed in an elliptical shape.

Since the method of the present invention uses the identification filter to block a portion of the fluorescence spectrum, the fluorescence can be observed in a truncated elliptical shape (see the right spectrum of FIG. 10). The truncated portion, that is, the blocked point, can be used as a reference point. The blocked point can be visually recognized and manually designated by a user. However, since a portion of the fluorescence spectrum is blocked linearly at the blocked point unlike in other portions, a recognition device controlled to automatically recognize linear light can also be used for automatic designation.

After completion of the recognition of the blocked point, the position and length of the dispersed fluorescence relative to the blocked point can be determined. When the identification filter blocks a short wavelength portion of the spectrum, an ellipse whose left side is truncated is observed (dispersed such that the left side has short wavelengths). Meanwhile, when the identification filter blocks a long wavelength portion of the spectrum, an ellipse whose right side is truncated is observed

Accordingly, the existence of fluorescence at the right side from the blocked point demonstrates the use of fluorophores emitting fluorescence having relatively short wavelength emission peaks. Meanwhile, the existence of fluorescence at the left side from the blocked point demonstrates the use of fluorophores emitting fluorescence having relatively long wavelength emission peaks. The observation of an ellipse whose both sides are truncated demonstrates the use of fluorophores having mid-wavelength emission peaks (see FIG. 11).

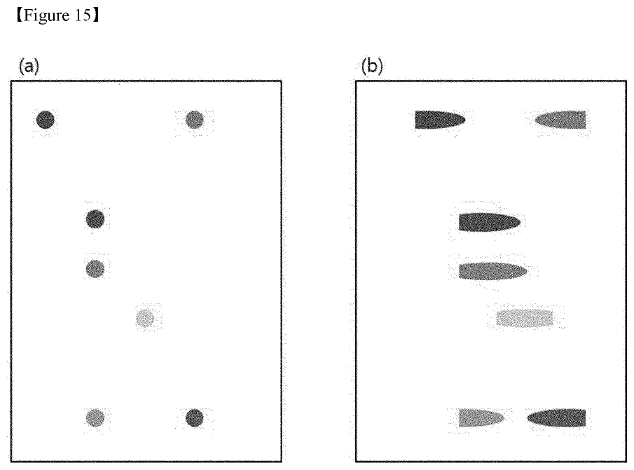

When a plurality of fluorophores forming fluorescence exist in the same direction from the blocked point, the total length of the fluorescence and the length to the thickest portion of the ellipse from the blocked point are measured to identify the type of the sample attached with the fluorophores (see FIG. 12). The total length of the fluorescence represents the total wavelength band of the fluorescence spectrum that is not blocked by the identification filter. The thickest portion of the ellipse represents the point of the emission peak generated by the fluorophores. Accordingly, by comprehensively observing both factors, the sample can be identified even when blocked point is formed in the same direction. This indicates that even when fluorescence of similar wavelengths is used, the type of the fluorescence can be easily identified, as shown in FIG. 15. As shown in (a) of FIG. 15, when fluorophores having similar emission colors are used, the types of the fluorophores may not be easy to identify. In contrast, as shown in (b) of FIG. 15, the identification filter and the spectroscopic means are used to disperse fluorescence and a portion of the fluorescence is blocked to identify the type of the fluorescence.

Preferred embodiments of the present invention will be described in detail with reference to the accompanying drawings such that those skilled in the art can readily practice the invention. In describing the present invention, detailed explanations of a related known function or construction are omitted when it is deemed that they may unnecessarily obscure the essence of the invention. Certain features shown in the drawings are enlarged, reduced or simplified for ease of illustration and the drawings and the elements thereof are not necessarily in proper proportion. However, those skilled in the art will readily understand such details.

### Example 1

As illustrated in FIG. 1, after the autofocus device was installed in the light source part, the position of the guide beam was determined by observing the sample focus measurement unit.

A laser having a peak wavelength of 850 nm was used as the guide beam and a filter reflecting 50% of the guide beam was used as the beam splitter.

The guide beam was fitted with a Gaussian function to determine the location coordinates of the guide beam. The fitting was continuously performed to express the center point of the guide beam as a Y coordinate.

A sample was irradiated with excitation light and observed with the camera 340 for sample observation. The position of the objective lens was finely adjusted such that the sample could be seen most clearly. As shown in FIG. 16, the position of the guide beam was determined to have an initial Y coordinate of 200 (yellow line).

An experiment was conducted to confirm the change of the guide beam depending on the distance between the sample plane and the objective lens. As shown in FIG. 16, the center of the guide beam moved by ˜10 pixels every time the distance moved by 1 μm (in FIG. 16, Z represents a variation in distance between the sample plane and the objective lens), demonstrating that when the y coordinate of the guide beam is maintained at 200, the distance between the sample plane and the objective lens can also be maintained.

As shown in FIG. 17, the fitting with a Gaussian function made it possible to determine the pixels up to decimal points rather than the integer multiple of the pixels, demonstrating that the use of the guide beam enables more precise control. The center of the guide beam moved by ˜10 pixels every time the distance moved by 1 μm. Accordingly, when the center of the guide beam moved by 1 pixel, 0.1 pixels, and 0.01 pixels, the distance between the sample plane and the objective lens moved by 100 nm, 10 nm, and 1 nm, respectively. In conclusion, the fitting with a Gaussian function enables more precise control.

### Example 2

Based on the results of Example 1, focus adjustment was performed on an actual sample having a thickness of several μm. For observation, the surface of the actual sample was covered with a slide glass. After an optimal focus was adjusted, a guide beam was irradiated. The shape of the guide beam was confirmed.

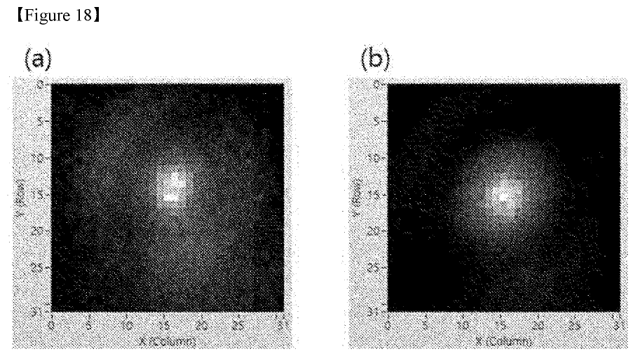

As shown in (a) of FIG. 18, the focus of the guide beam was blurred due to the sample thickness. The focus of the guide beam was readjusted using the guide beam focus control means installed in the sample focus measurement unit. As a result, the shape of the guide beam could be clearly confirmed, as shown in (b) of FIG. 18.

Although the particulars of the present invention have been described in detail, it will be obvious to those skilled in the art that such particulars are merely preferred embodiments and are not intended to limit the scope of the present invention. Therefore, the true scope of the present invention is defined by the appended claims and their equivalents.

1. An autofocus device comprising a guide beam generation unit installed in a light source part of a fluorescence microscope to supply a guide beam in a direction towards a sample plane and a sample focus measurement unit measuring the guide beam reflected from the sample plane to detect a change in distance between the sample plane and an objective lens.

2. The autofocus device according to claim 1, wherein the autofocus device comprises a beam splitter reflecting a portion of the guide beam and installed obliquely to a traveling direction of the guide beam and wherein the guide beam supplied from the guide beam generation unit passes through the beam splitter, is supplied to the sample plane, and is reflected from the sample plane and a portion of the guide beam reflected from the sample plane is reflected by the beam splitter and enters the sample focus measurement unit.

3. The autofocus device according to claim 1, wherein the guide beam generation unit supplies the guide beam such that the relative direction and position of the guide beam with respect to an optical axis of the objective lens are controlled, and the optical axis of the objective lens and the guide beam form an angle of 0° to 20°.

4. The autofocus device according to claim 2, wherein the beam splitter reflects 10 to 50% of the guide beam.

5. The autofocus device according to claim 1, wherein the sample focus measurement unit comprises a tube lens on which the guide beam reflected from the sample plane is incident and a camera for sample focus measurement determining the position of the guide beam having passed through the tube lens.

6. The autofocus device according to claim 5, wherein the sample focus measurement unit comprises a guide beam position monitor measuring a change in the position of the guide beam and a sample focal distance controller controlling the distance between the objective lens of the fluorescence microscope and the sample plane based on data measured in the guide beam position monitor.

7. The autofocus device according to claim 5, wherein the sample focus measurement unit comprises an excitation light blocking filter capable of blocking excitation light from entering the camera for sample focus measurement.

8. The autofocus device according to claim 1, wherein the autofocus device comprises a guide beam focus control means capable of controlling the focus of the guide beam between the guide beam generation unit and the sample focus measurement unit.

9. The autofocus device according to claim 8, wherein the guide beam focus control means comprises a control means installed in front of the guide beam and consisting of two or more lenses to change the focal distance of the guide beam incident on the sample plane or a control means installed in front of the sample focus measurement unit to change the focal position of the guide beam entering the camera for sample focus measurement.

10. A method for autofocus measurement for a fluorescence microscope using the autofocus device according to claim 1.

11. The method according to claim 10, wherein the method comprises supplying a guide beam to a sample plane from the guide beam generation unit, determining the position of the guide beam reflected from the sample plane and entering the camera for sample focus measurement, and detecting a change in the position of the guide beam to control the distance between the objective lens of the fluorescence microscope and the sample plane.

12. The method according to claim 11, wherein the method comprises, before supplying a guide beam to a sample plane, supplying a sample for focus control to an objective part, controlling the distance between the objective lens and the sample plane to focus on the sample, and removing the sample for focus control and supplying a sample for fluorescence measurement.

13. The method according to claim 11, wherein the determination of the position of the guide beam comprises focusing the guide beam entering the camera for sample focus measurement using the guide beam focus control means.
